(19) United States
(12) Patent Application Publication
(10) Pub. No.: US 2006/0080980 A1
(43) Pub. Date: Apr. 20, 2006

(54) Apparatus and method for controlling compressors of multi-chamber type air conditioner

(75) Inventors: Seung Kwan Lee, Suwon-Si (KR); Min Jae Ok, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., LTD, Suwon-si (KR)

(21) Appl. No.: 11/152,141

(22) Filed: Jun. 15, 2005

(30) Foreign Application Priority Data
Oct. 15, 2004 (KR) 2004-82428

(51) Int. Cl. G05D 23/32; F25B 7/00; F25B 5/00; F25B 1/10

(52) U.S. Cl. 62/157; 62/175; 62/199; 62/510

(57) ABSTRACT

Apparatus and method for controlling compressors of a multi-chamber type air conditioner. The apparatus includes an operating time-accumulating unit for accumulating operating times of the plural compressors; a storage unit for storing the cumulative operating times obtained by the operating time-accumulating unit; indoor control units for respectively controlling the indoor units; and an outdoor control unit for selecting compressors to be operated based on the cumulative operating times of the compressors and controlling the operations of the selected compressors, when it is necessary to operate at least one compressor based on air conditioning loads required by the indoor control units. The apparatus provides uniform chances of operation to all the compressors, thereby providing convenience in replacing the compressors with new ones and checking the life spans of the compressors.

### CROSS-REFERENCE TO RELATED APPLICATION

This application claims the benefit of Korean Patent Application No. 2004-82428, filed Oct. 15, 2004, in the Korean Intellectual Property Office, the disclosure of which is incorporated herein by reference.

### BACKGROUND OF THE INVENTION

1. Field of the Invention

The present invention relates to an apparatus and method for controlling compressors of a multi-chamber type air conditioner, and more particularly, to an apparatus and method for controlling a plurality of compressors of a multi-chamber type air conditioner such that the compressors are uniformly operated.

2. Description of Related Art

Generally, a multi-chamber type conditioner includes one outdoor unit and a plurality of indoor units connected to the outdoor unit. Each of the indoor units includes an indoor heat exchanger and an indoor electric valve, and the outdoor unit includes a plurality of compressors.

When the number of the indoor units to be operated is increased, the capacities of the compressors are varied in order to cope with the required capacities of the indoor units. When the outdoor unit of the multi-chamber type conditioning system includes a plurality of the compressors, the number of the compressors to be operated is determined in consideration of the air conditioning loads required by the indoor units.

When the plural compressors of the conventional multi-chamber type air conditioner are operated, the number of the compressors to be operated is determined such that the air conditioning loads of the indoor units are satisfied, and the compressors of the determined number are operated. Here, a method for increasing or decreasing the number of the compressors to be operated in the order of numbers defined to the compressors is used.

Thereby, the compressors having relatively small numbers are more frequently operated, while the compressors having relatively large numbers are less frequently operated. Accordingly, the compressors which are frequently operated have shorter life spans, thus being more rapidly replaced with a new one, while the compressors which are less frequently operated have longer life spans, thus being capable of being continuously operated.

When the compressors are impartially operated as described above, since the life spans of the compressors differ from each other, it is difficult to simultaneously replace the compressors with new ones, it is necessary to frequently check whether or not the compressors have exhausted their life spans, and the replacement of the compressors is frequently required.

Thus, there is a need for an apparatus and method for controlling compressors of a multi-chamber type air conditioner, in which a plurality of the compressors are uniformly operated, thereby facilitating the checking and replacing of the compressors

### BRIEF SUMMARY

According to an aspect of the present invention, there is provided an apparatus for controlling plural compressors of a multi-chamber type air conditioner, in which a plurality of indoor units are connected to an outdoor unit having the plural compressors so that the air conditioner performs an air conditioning operation. The apparatus includes: an operating time-accumulating unit accumulating operating times of the plural compressors; a storage unit storing the cumulative operating times; indoor control units respectively controlling the indoor units; and an outdoor control unit selecting compressors to be operated based on the cumulative operating times and controlling operations of the selected compressors, when it is necessary to operate at least one compressor based on air conditioning loads required by the indoor control units.

The outdoor control unit may give a higher probability of operation to one of the compressors having a low cumulative operating time rather than one of the compressors having a high cumulative operating time.

The outdoor control unit may additionally operate one of the plural compressors having a low cumulative operating time from among stopped ones of the compressors when it is necessary to increase a number of the compressors to be operated, and stop operating one of the plural compressors having a high cumulative operating time from among operating ones of compressors when it is necessary to decrease the number of the compressors to be operated.

When the operation one of the plural compressors is stopped, the outdoor control unit may replace a previous cumulative operating time of the stopped compressor by storing a new cumulative operating time of the compressor in the storage unit.

The outdoor control unit may give priorities to each of the plural compressors based on the cumulative operating times thereof, store the priorities given to the compressors in the storage unit, and select compressors to be operated based on the priorities when it is necessary to operate at least one compressor.

According to another aspect of the present invention, there is provided an apparatus for controlling plural compressors of a multi-chamber type air conditioner, in which a plurality of indoor units are connected to an outdoor unit having the plural compressors so that the air conditioner performs an air conditioning operation. The apparatus includes: a storage unit storing cumulative operating times and priorities to each of the plural compressors; indoor control units respectively controlling the indoor units; and an outdoor control unit giving the priorities to the compressors based on the cumulative operating times of the compressors, and selecting compressors to be operated based on the priorities when the number of the compressors to be operated is to be increased or decreased based on air conditioning loads required by the indoor control units.

The outdoor control unit may give higher priorities to the ones of the compressors having higher cumulative operating times.

The outdoor control unit may additionally operate one of the plural compressors having a lower priority among stopped ones of the compressors when it is necessary to increase the number of the compressors to be operated, and stops operating one of the plural compressors having a high priority among operating ones of the compressors when it is necessary to decrease the number of the compressors to be operated.

According to another aspect of the present invention, there is provided a method of controlling plural compressors of a multi-chamber type air conditioner, in which a plurality of indoor units are connected to an outdoor unit having the plural compressors so that the air conditioner performs an air conditioning operation. The method includes: selecting compressors to be operated based on cumulative operating times of the compressors when at least one compressor is operated; accumulating the cumulative operating times of the selected compressors and storing the obtained cumulative operating times during the operations of the selected compressors; determining whether it is necessary to increase or decrease a number of the compressors to be operated during the operations of the compressors; and additionally operating one of the plural compressors having a low cumulative operating time from among stopped ones of the compressors when it is necessary to increase the number of the compressors to be operated, and stopping operation of one of the plural compressors having a high cumulative operating time from among operating ones of the compressors when it is necessary to decrease the number of the compressors to be operated.

Priorities may be given to the compressors based on the cumulative operating times of the compressors, and the compressors to be operated are selected based on the priorities.

When the operations of the compressors are stopped, prior cumulative operating times of the stopped compressors may be replaced with new cumulative operating times and stored.

an apparatus for uniformly operating plural compressors, including: an operating time-accumulating unit accumulating operating times of the plural compressors; a storage unit storing the cumulative operating times; and a control unit selecting compressors to be operated based on the cumulative operating times of the compressors, when it is necessary to operate at least one compressor.

a method of uniformly operating plural compressors, including: selecting compressors to be operated based on cumulative operating times of the compressors when at least one compressor is operated; accumulating the cumulative operating times of the selected compressors and storing the obtained cumulative operating times; additionally operating one of the plural compressors having a low cumulative operating time from among unoperated ones of the plural compressors when it is necessary to increase the number of the compressors to be operated, and stopping operation of one of the plural compressors having a high cumulative operating time from among operating ones of the compressors when it is necessary to decrease the number of the compressors to be operated.

Additional and/or other aspects and advantages of the present invention will be set forth in part in the description which follows and, in part, will be obvious from the description, or may be learned by practice of the invention.

### BRIEF DESCRIPTION OF THE DRAWINGS

These and/or other aspects and advantages of the present invention will become apparent and more readily appreciated from the following detailed description, taken in conjunction with the accompanying drawings of which:

FIG. 1 is a schematic view of an apparatus for controlling compressors of a multi-chamber type air conditioner in accordance with the present invention;

FIG. 2 is a table stating priorities given to the compressors according to variations of the cumulative operating times of a plurality of the compressors of the multi-chamber type air conditioner in accordance with the present invention; and

FIG. 3 is a flowchart illustrating a method of controlling the compressors of the multi-chamber type air conditioner in accordance with the present invention.

### DETAILED DESCRIPTION OF EMBODIMENT

Reference will now be made in detail to an embodiment of the present invention, examples of which are illustrated in the accompanying drawings, wherein like reference numerals refer to the like elements throughout. The embodiment is described below in order to explain the present invention by referring to the figures.

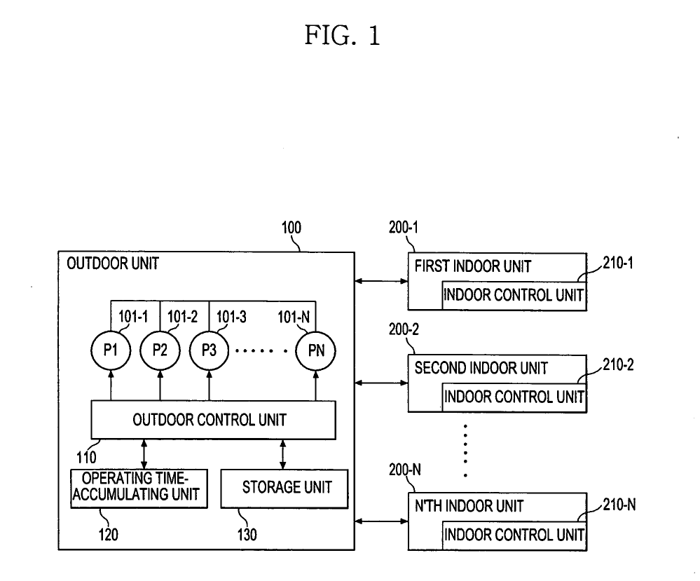

A multi-chamber type air conditioner in accordance with an embodiment of the present invention, as shown in FIG. 1, includes an outdoor unit 100, a plurality of indoor units 200-1˜200-N. The outdoor unit 100 includes a plurality of compressors 101-1˜101-N, and an outdoor control unit 110 for controlling the operation of the outdoor unit 100. The number of the compressors 101-1˜101-N is set in consideration of the sum total of capacities of indoor heat exchangers. Although the compressors of this embodiment are compressors having stationary capacities, the compressors are not limited thereto, and can use the combination of compressors having variable capacities and compressors having stationary capacities.

Each of the indoor units 200-1˜200-N, which may be, for example, installed in corresponding rooms, includes an indoor heat exchanger, an indoor electric valve, an indoor fan, and an indoor temperature sensor, which are not shown, and an indoor control unit 210-1˜210-N for controlling the operation of each of the indoor units 200-1˜200-N.

A capacity (air conditioning load), required by the indoor units 200-1˜200-N when the multi-chamber type air conditioner is operated, is variable, and thus the outdoor control unit 110 sets the number of the compressors 101-1˜101-N to be operated according to the above capacity.

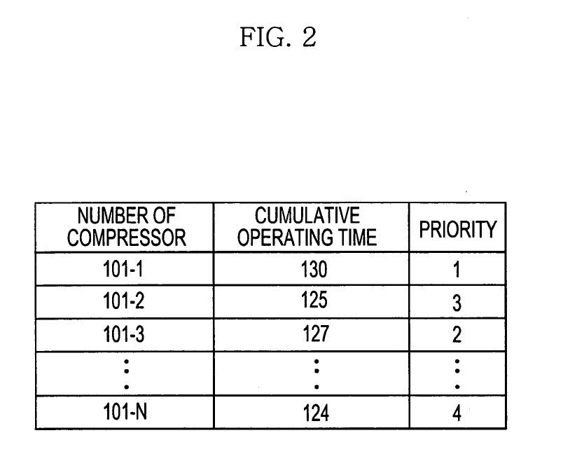

The outdoor control unit 110 compares the cumulative operating times of the plural compressors 101-1˜101-N to each other, gives priorities to the compressors 101-1˜101-N, and increases or decreases of the number of the compressors to be operated based on the priorities of the compressors 101-1˜101-N. For this reason, the outdoor unit 100 includes an operating time-accumulating unit 120 for accumulating the operating times of the plural compressors 101-1˜101-N, and a storage unit 130 for storing the cumulative operating times and the priorities of the compressors 101-1˜101-N by the control of the outdoor control unit 110. The storage unit 130, as shown in FIG. 2, stores a table, which gives the cumulative operating times and the priorities to the compressors 101-1˜101-N. Here, the higher greater the cumulative operating time of the compressor, the lower the priority number it is given and thus the higher priority it is given.

The outdoor control unit 110 bi-directionally communicates with the indoor control units 210-1˜210-N through, for example, signal lines connected therebetween, and the indoor control units 210-1˜210-N supply data regarding the air conditioning loads of the corresponding rooms to the outdoor control unit 110. The outdoor control unit 110 sets the number of the compressors to be operated so as to satisfy the air conditioning loads supplied from the indoor units 210-1˜210-N. Here, the outdoor control unit 110 searches the priorities, given to the compressors based on the cumulative operating times of the compressors, from the storage unit 130, and determines which compressors are to be operated.

Since the air conditioning load of the room is varied during the operations of the compressors, it is necessary to increase or decrease the number of the compressors to be operated. Here, the outdoor control unit 110 sets the number of the compressors to be operated such that the cumulative operating times of all of the compressors 101-1˜101-N are uniform. That is, in case that the number of the compressors to be operated is increased, the outdoor control unit 110 additionally operates a compressor having a low cumulative operating time among the compressors which are stopped. On the other hand, when the number of the operating compressors is to be decreased, the outdoor control unit 110 stops operating a compressor having a high cumulative operating time among the compressors which are operating.

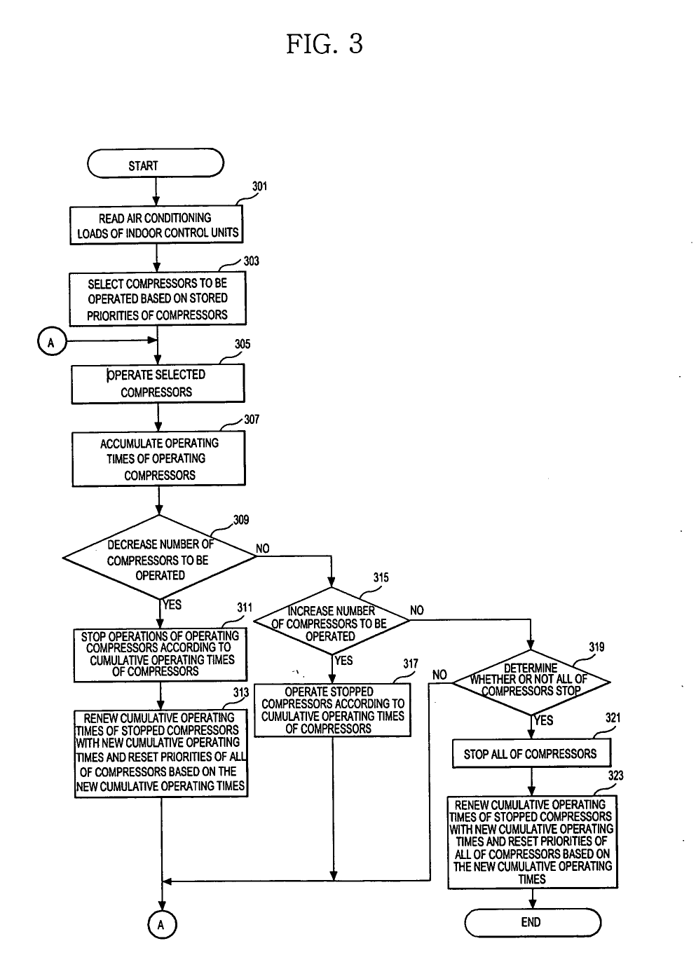

Hereinafter, with reference to FIG. 3, a method of controlling compressors of the multi-chamber type air conditioner of an embodiment of the present invention will be described. Since the method can be performed by the apparatus of FIG. 1, it will be explained with reference to FIG. 1. However, it is to be understood that the method of FIG. 3 can be performed by other apparatuses.

First, the outdoor control unit 110 receives air conditioning loads required by rooms from the indoor control units 210-1˜210-N, and determines necessary capacities of compressors based on the received air conditioning loads (S301).

The outdoor control unit 110 sets the number of the compressors to be operated in proportion to the necessary capacities of the compressors. Here, the outdoor control unit 110 searches the storage unit 130 so as to select the compressors having lower cumulative operating times, and gives preference to perform operations from the compressors having a low priority (S303).

The outdoor control unit 110 operates at least one compressor among the selected compressors (S305).

During the operations of the compressors, the operating time-accumulating unit 120 accumulates operating times of the operating compressors, and supplies the obtained cumulative operating times to the outdoor control unit 110 (S307). The outdoor control unit 110 determines whether or not it is necessary to increase or decrease the number of the compressors to be operated based on the air conditioning loads supplied from the indoor control units 210-1˜210-N (S309).

Based on the result of the determination of operation S309, when it is determined that it is necessary to decrease the number of the compressors to be operated, the outdoor control unit 110 searches the storage unit 130, and selects the compressors to be stopped (S311). That is, the outdoor control unit 110 stops operating compressors having a high cumulative operating time. Here, the outdoor control unit 110 renews the cumulative operating time already stored in the storage unit 130 with a new cumulative operating time of the above stopped compressor, and resets the priorities of all of the compressors in consideration of the new cumulative operating time stored in the storage unit 130 (S313). Thereafter, operation S307 is performed.

Based on the result of the determination of operation S309, when it is determined that it is unnecessary to decrease the number of the compressors to be operated, the outdoor control unit 110 determines whether or not it is necessary to increase the number of the compressors to be operated based on the air conditioning loads supplied from the indoor control units (210-1˜210-N) (S315).

Based on the result of the determination of operation S315, when it is determined that it is necessary to increase the number of the compressors to be operated, the outdoor control unit 110 searches the storage unit 130, and selects the compressors to be additionally operated (S317). Here, the outdoor control unit 110 additionally operates a compressor having a low cumulative operating time. Thereafter, operation S307 is performed.

Based on the result of the determination of operation S315, when it is determined that it is unnecessary to increase the number of the compressors to be operated, the outdoor control unit 110 determines whether of not all the compressors are stopped (S319). Based on the result of the determination of operation S319, in case that it is determined that it is unnecessary to stop all the compressors, operation S307 is performed.

Based on the result of the determination of operation S319, when it is determined that it is necessary to stop all the compressors, the outdoor control unit 110 stops the operations of all the compressors (S321), renews the cumulative operating times already stored in the storage unit 130 with new cumulative operating times of the stopped compressors in the storage unit 130, and resets the priorities of all the compressors in consideration of the new cumulative operating times stored in the storage unit 130 (S323).

The above-described embodiment of the present invention provides an apparatus and method for controlling compressors of a multi-chamber type air conditioner, in which operating times of a plurality of the compressors are accumulated and compressors to be operated are set according to the cumulative operating times thereof. Thereby, chances of respectively operating all the compressors are uniform so that the compressors have similar life spans determined by the cumulative operating times and are simultaneously replaced with new compressors, thus providing convenience in replacing the compressors with new ones and checking the life spans of the compressors.

Although an embodiment of the present invention have been shown and described, the present invention is not limited to the described embodiment. Instead, it would be appreciated by those skilled in the art that changes may be made to the embodiment without departing from the principles and spirit of the invention, the scope of which is defined by the claims and their equivalents.

What is claimed is:

1. An apparatus for controlling plural compressors of a multi-chamber type air conditioner, in which a plurality of indoor units are connected to an outdoor unit having the plural compressors so that the air conditioner performs an air conditioning operation, comprising:
an operating time-accumulating unit accumulating operating times of the plural compressors;
a storage unit storing the cumulative operating times;
indoor control units respectively controlling the indoor units; and
an outdoor control unit selecting compressors to be operated based on the cumulative operating times and controlling operations of the selected compressors, when it is necessary to operate at least one compressor based on air conditioning loads required by the indoor control units.

2. The apparatus as set forth in claim 1, wherein the outdoor control unit gives a higher probability of operation to one of the compressors having a low cumulative operating time rather than one of the compressors having a high cumulative operating time.

3. The apparatus as set forth in claim 2, wherein the outdoor control unit additionally operates one of the plural compressors having a low cumulative operating time from among stopped ones of the compressors when it is necessary to increase a number of the compressors to be operated, and stops operating one of the plural compressors having a high cumulative operating time from among operating ones of compressors when it is necessary to decrease the number of the compressors to be operated.

4. The apparatus as set forth in claim 3, wherein, when the operation one of the plural compressors is stopped, the outdoor control unit replaces a previous cumulative operating time of the stopped compressor by storing a new cumulative operating time of the compressor in the storage unit.

5. The apparatus as set forth in claim 1, wherein the outdoor control unit gives priorities to each of the plural compressors based on the cumulative operating times thereof, stores the priorities given to the compressors in the storage unit, and selects compressors to be operated based on the priorities when it is necessary to operate at least one compressor.

6. An apparatus for controlling plural compressors of a multi-chamber type air conditioner, in which a plurality of indoor units are connected to an outdoor unit having the plural compressors so that the air conditioner performs an air conditioning operation, comprising:
a storage unit storing cumulative operating times and priorities to each of the plural compressors;
indoor control units respectively controlling the indoor units; and
an outdoor control unit giving the priorities to the compressors based on the cumulative operating times of the compressors, and selecting compressors to be operated based on the priorities when the number of the compressors to be operated is to be increased or decreased based on air conditioning loads required by the indoor control units.

7. The apparatus as set forth in claim 6, wherein the outdoor control unit gives higher priorities to the ones of the compressors having higher cumulative operating times.

8. The apparatus as set forth in claim 7, wherein the outdoor control unit additionally operates one of the plural compressors having a lower priority among stopped ones of the compressors when it is necessary to increase the number of the compressors to be operated, and stops operating one of the plural compressors having a high priority among operating ones of the compressors when it is necessary to decrease the number of the compressors to be operated.

9. A method of controlling plural compressors of a multi-chamber type air conditioner, in which a plurality of indoor units are connected to an outdoor unit having the plural compressors so that the air conditioner performs an air conditioning operation, comprising:
selecting compressors to be operated based on cumulative operating times of the compressors when at least one compressor is operated;
accumulating the cumulative operating times of the selected compressors and storing the obtained cumulative operating times during the operations of the selected compressors;
determining whether it is necessary to increase or decrease a number of the compressors to be operated during the operations of the compressors; and
additionally operating one of the plural compressors having a low cumulative operating time from among stopped ones of the compressors when it is necessary to increase the number of the compressors to be operated, and stopping operation of one of the plural compressors having a high cumulative operating time from among operating ones of the compressors when it is necessary to decrease the number of the compressors to be operated.

10. The method as set forth in claim 9, wherein priorities are given to the compressors based on the cumulative operating times of the compressors, and the compressors to be operated are selected based on the priorities.

11. The method as set forth in claim 9, wherein, when the operations of the compressors are stopped, prior cumulative operating times of the stopped compressors are replaced with new cumulative operating times and stored.

12. An apparatus for uniformly operating plural compressors, comprising:
an operating time-accumulating unit accumulating operating times of the plural compressors;
a storage unit storing the cumulative operating times; and
a control unit selecting compressors to be operated based on the cumulative operating times of the compressors, when it is necessary to operate at least one compressor.

13. The apparatus as set forth in claim 12, wherein the control unit selects a number of compressors to be operated so as to satisfy air conditioning loads requested by indoor units.

14. The apparatus as set forth in claim 12, wherein the control unit gives each compressor a priority based on the cumulative operating time of the compressor and, when selecting compressors to be operated, searches the priorities given to the compressors to make the selection.

15. The apparatus as set forth in claim 14, wherein the control unit gives high priorities to ones of the compressors with high cumulative operating times and low priorities to ones of the compressors with low cumulative priority times,
wherein the control unit, when a number of compressors to be operated is to be decreased, stops operating one of the plural compressors having a high priority, and
wherein the control unit, when a number of compressors to be operated is to be increased, starts operating one of the plural compressors having a low priority.

16. A method of uniformly operating plural compressors, comprising:
selecting compressors to be operated based on cumulative operating times of the compressors when at least one compressor is operated;
accumulating the cumulative operating times of the selected compressors and storing the obtained cumulative operating times;
additionally operating one of the plural compressors having a low cumulative operating time from among unoperated ones of the plural compressors when it is necessary to increase the number of the compressors to be operated, and stopping operation of one of the plural compressors having a high cumulative operating time from among operating ones of the compressors when it is necessary to decrease the number of the compressors to be operated.
